(19) United States
(12) Patent Application Publication
(10) Pub. No.: US 2014/0205134 A1
(43) Pub. Date: Jul. 24, 2014

(54) ELECTRONIC DEVICE

(71) Applicants: Ayumu Yagihashi, Kanagawa (JP); Kenichi Kitatani, Kanagawa (JP); Hiroyuki Aoki, Kanagawa (JP); Yumi Katou, Kanagawa (JP); Atsuhiko Murayama, Kanagawa (JP); Seiji Sugahara, Tokyo (JP)

(72) Inventors: Ayumu Yagihashi, Kanagawa (JP); Kenichi Kitatani, Kanagawa (JP); Hiroyuki Aoki, Kanagawa (JP); Yumi Katou, Kanagawa (JP); Atsuhiko Murayama, Kanagawa (JP); Seiji Sugahara, Tokyo (JP)

(73) Assignee: NEC CASIO MOBILE COMMUNICATIONS, LTD., Kanagawa (JP)

(21) Appl. No.: 14/342,964

(22) PCT Filed: Sep. 7, 2012
(86) PCT No.: PCT/JP2012/005680

§ 371 Date: Mar. 5, 2014

(30) Foreign Application Priority Data
Sep. 8, 2011 (JP) 2011-195759
Sep. 8, 2011 (JP) 2011-195760

(51) Int. Cl. H04R 3/00

(52) U.S. Cl. CPC H04R 3/00
USPC 381/387

(57) ABSTRACT

Provided is an electronic device including a plurality of oscillators (12) each of which outputs a modulated wave of a parametric speaker, a display (40) that displays image data, a recognition unit (30) that recognizes positions of a plurality of users, and a control unit (20) that controls the oscillator (12) to reproduce audio data associated with the image data, the control unit (20) controls the oscillator (12) to reproduce the audio data, according to a volume or a quality which are set for each user, toward the position of each user which is recognized by the recognition unit (30).

### TECHNICAL FIELD

The present invention relates to an electronic device having an oscillator.

### BACKGROUND ART

Technologies relating to electronic devices having audio output units are described, for example, in Patent Documents 1 to 8. The technology described in Patent Document 1 is intended to measure a distance between a mobile terminal and a user and to control a brightness of a display and a volume of a speaker. The technology described in Patent Document 2 is intended to determine whether an input audio signal corresponds to a speech or a non-speech by using a music characteristic detection unit and a speech characteristic detection unit and to adjust an audio to be output based on the determination.

The technology described in Patent Document 3 is intended to reproduce an audio suitable for both the hard of hearing and normal hearing people by using a speaker control device having a high directional speaker and a regular speaker. The technology described in Patent Document 4 is a technology relating to a directional speaker system having a directional speaker array. Specifically, control points for reproduction are disposed in a main lobe direction so as to suppress deterioration in reproduced sounds.

Technologies relating to parametric speakers are described in Patent Documents 5 to 8. The technology described in Patent Document 5 is intended to control the frequency of a carrier signal of the parametric speaker depending on a demodulation distance. The technology described in Patent Document 6 relates to a parametric audio system having a sufficiently high carrier frequency. The technology described in Patent Document 7 has an ultrasonic wave generator which generates an ultrasonic wave by using the expansion and contraction of a medium due to the heat of a heating body. The technology described in Patent Document 8 relates to a portable terminal device having a plurality of ultra-directional speakers such as a parametric speaker.

### RELATED DOCUMENT

### Patent Document

[Patent Document 1] Japanese Unexamined Patent Publication No. 2005-202208

[Patent Document 2] Japanese Unexamined Patent Publication No. 2010-231241

[Patent Document 3] Japanese Unexamined Patent Publication No. 2008-197381

[Patent Document 4] Japanese Unexamined Patent Publication No. 2008-252625

[Patent Document 5] Japanese Unexamined Patent Publication No. 2006-81117

[Patent Document 6] Japanese Unexamined Patent Publication No. 2010-51039

[Patent Document 7] Japanese Unexamined Patent Publication No. 2004-147311

[Patent Document 8] Japanese Unexamined Patent Publication No. 2006-67386

### DISCLOSURE OF THE INVENTION

An object of the present invention is to reproduce an audio suitable for each user, when a plurality of users simultaneously view the same content.

According to according to the present invention, there is provided an electronic device including:

a plurality of oscillators each of which outputs a modulated wave of a parametric speaker;

a display that displays a first image data;

a recognition unit that recognizes positions of a plurality of users; and

a control unit that controls the oscillator to reproduce audio data associated with the first image data,

wherein the control unit controls the oscillator to reproduce the audio data, according to a volume and a quality which are set for each user, toward the position of each user which is recognized by the recognition unit.

Further, according to the present invention, there is provided an electronic device including:

a plurality of oscillators each of which outputs a modulated wave of a parametric speaker;

a display that displays a first image data including a plurality of display objects;

a recognition unit that recognizes positions of a plurality of users; and

a control unit that controls the oscillator to reproduce a plurality of pieces of audio data respectively associated with the plurality of display objects,

wherein the control unit controls the oscillator to reproduce the audio data associated with the display object selected by each user, toward the position of each user which is recognized by the recognition unit.

According to the present invention, it is possible to reproduce an audio suitable for each user, when a plurality of users simultaneously view the same content.

### BRIEF DESCRIPTION OF THE DRAWINGS

The above-mentioned objects, other objects, features and advantages will be made clearer from the preferred embodiments described below and the following accompanying drawings.

FIG. 1 is a schematic diagram showing an operation method of an electronic device according to a first embodiment.

FIG. 2 is a block diagram showing the electronic device shown in FIG. 1.

FIG. 3 is a plan view showing a parametric speaker shown in FIG. 2.

FIG. 4 is a cross-sectional view showing an oscillator shown in FIG. 3.

FIG. 5 is a cross-sectional view of a piezoelectric vibrator shown in FIG. 4.

FIG. 6 is a flowchart of an operation method of the electronic device shown in FIG. 1.

FIG. 7 is a block diagram showing an electronic device according to a second embodiment.

FIG. 8 is a schematic diagram showing an operation method of an electronic device according to a third embodiment.

FIG. 9 is a block diagram showing the electronic device shown in FIG. 8.

FIG. 10 is a flowchart of an operation method of the electronic device shown in FIG. 8.

FIG. 11 is a block diagram showing an electronic device according to a fourth embodiment.

### DESCRIPTION OF EMBODIMENTS

Hereinafter, embodiments of the present invention will be described with reference to drawings. Further, in the entire drawings, the same components are denoted by the same reference numerals, and thus the description thereof will not be repeated.

### First Embodiment

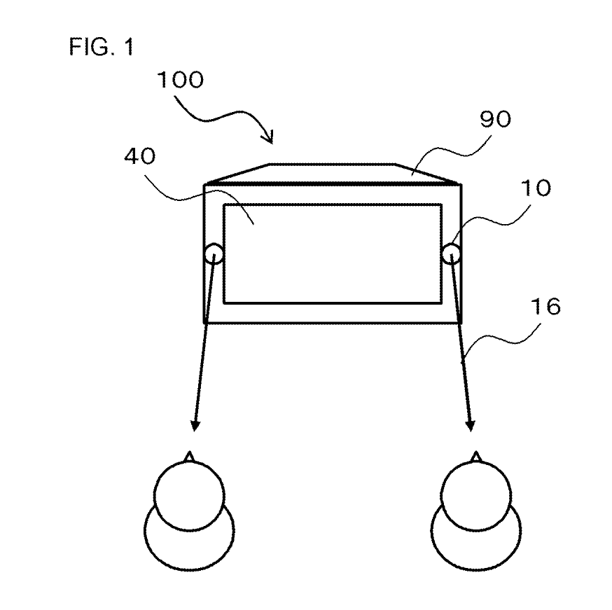

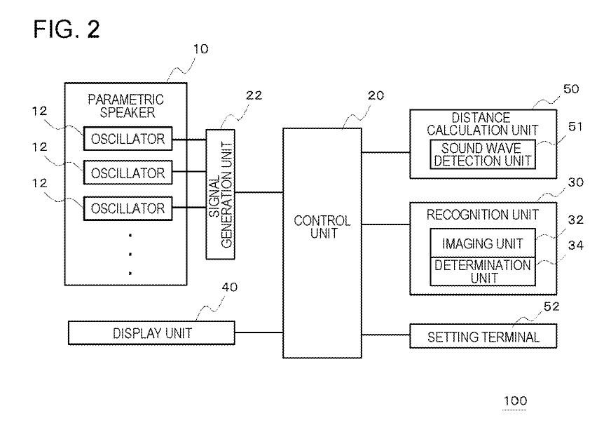

FIG. 1 is a schematic diagram showing an operation method of an electronic device 100 according to a first embodiment. In addition, FIG. 2 is a block diagram showing the electronic device 100 shown in FIG. 1. The electronic device 100 according to the present embodiment includes a parametric speaker 10 having a plurality of oscillators 12, a display 40, a recognition unit 30, and a control unit 20. The electronic device 100 is, for example, a television, a display for a digital signage, a portable terminal device, or the like. The portable terminal device is, for example, a mobile phone or the like.

The oscillator 12 outputs an ultrasonic wave 16. The ultrasonic wave 16 is a modulated wave of the parametric speaker. The display 40 displays image data. The recognition unit 30 recognizes the positions of a plurality of users. The control unit 20 controls the oscillator 12 to reproduce audio data associated with the image data displayed on the display 40.

The control unit 20 controls the oscillator 12 to reproduce the audio data, according to a volume and a quality which is set for each user, toward the position of each user which is recognized by the recognition unit 30. Hereinafter, the configuration of the electronic device 100 will be described in detail using FIGS. 1 to 5.

As shown in FIG. 1, the electronic device 100 includes a housing 90. The parametric speaker 10, the display 40, the recognition unit 30, and the control unit 20 are disposed inside, for example, the housing 90 (not shown).

The electronic device 100 receives or stores content data. The content data includes the audio data and the image data. The display data out of the content data is displayed on the display 40. In addition, the audio data out of the content data is associated with the image data and is output by the plurality of oscillators 12.

As shown in FIG. 2, the recognition unit 30 includes an imaging unit 32 and a determination unit 34. The imaging unit 32 captures an area including a plurality of users to generate image data. The determination unit 34 processes the image data captured by the imaging unit 32 and determines the position of each user. For example, a characteristic value for identifying each user is stored and preserved individually in advance, and the characteristic value is compared with the image data so as to perform the determination of the position of each user. The characteristic value is, for example, a size of an interval of both eyes, a size or a shape of a triangle formed by connecting both eyes and the nose, or the like.

The recognition unit 30 can specify, for example, the position of the ear of the user, or the like. In addition, when the user moves within the area in which the imaging unit 32 captures an image, the recognition unit 30 may have a function of automatically following the user and determining the position of the user.

As shown in FIG. 2, the electronic device 100 includes a distance calculation unit 50. The distance calculation unit 50 calculates a distance between each user and the oscillator 12.

As shown in FIG. 2, the distance calculation unit 50 includes, for example, a sound wave detection unit 51. In this case, the distance calculation unit 50 calculates the distance between each user and the oscillator 12, for example, in the following manner. First, an ultrasonic wave for a sensor is output from the oscillator 12. Subsequently, the distance calculation unit 50 detects the ultrasonic wave for a sensor which is reflected from each user. Then, based on time from when the ultrasonic wave for a sensor is output by the oscillator 12 until it is detected by the sound wave detection unit 51, the distance between each user and the oscillator 12 is calculated. In addition, when the electronic device 100 is a mobile phone, the sound wave detection unit 51 may be configured with, for example, a microphone.

As shown in FIG. 2, the electronic device 100 includes a setting terminal 52. The setting terminal 52 sets, for example, the volume or the quality of the audio data associated with image data which is displayed on the display 40 for each user. The setting of the volume or the quality by the setting terminal 52 is performed by, for example, each user. This enables each user to set the volume or the quality which is optimal for the user.

The setting terminal 52 is incorporated, for example, inside the housing 90. In addition, the setting terminal 52 may not be incorporated inside the housing 90. In this case, a plurality of the setting terminals 52 may be provided in order for each user to have each one of the setting terminal 52.

As shown in FIG. 2, the control unit 20 is connected to the plurality of oscillators 12, the recognition unit 30, the display 40, the distance calculation unit 50, and the setting terminal 52. The control unit 20 controls the oscillator 12 to reproduce the audio data, according to the volume and the quality which is set for each user, toward the position of each user. The volume of the audio data to be reproduced is controlled by adjusting, for example, the output of the audio data. In addition, the quality of the audio data to be reproduced is controlled by changing, for example, the setting of an equalizer for processing the audio data before modulation.

In addition, the control unit 20 may be configured to control only any one of the volume and the quality.

The control of the oscillator 12 by the control unit 20 is performed, for example, in the following manner.

First, the characteristic value of each user is registered in association with an ID. Subsequently, the volume and the quality which are set for each user are stored in association with the ID of each user. Subsequently, the ID corresponding to the setting of a specific volume and quality is selected, and the characteristic value associated with the selected ID is read. Subsequently, the user having the characteristic value which is read, is selected by processing the image data generated by the imaging unit 32. The audio corresponding to the selected setting is reproduced for the user.

In addition, when the position of the ear of the user is specified by the recognition unit 30, the control unit 20 can control the oscillator 12 to output the ultrasonic wave 16 toward the position of the ear of the user.

The control unit 20 adjusts the volume and the quality of the audio data to be reproduced for each user, based on the distance between each user and the oscillator 12 which is calculated by the distance calculation unit. In other words, the control unit 20 controls the oscillator 12 to reproduce the audio data, according to the volume and the quality which are set by each user, toward the position of each user, based on the distance between each user and the oscillator 12.

For example, the volume of the audio data to be reproduced is adjusted by controlling the output of the audio data based on the distance between each user and the oscillator 12. Thus, it is possible to reproduce the audio data for each user, according to the suitable volume which is set for each user.

In addition, for example, the quality of the audio data to be reproduced is adjusted by processing the audio data before modulation based on the distance between each user and the oscillator 12. Thus, it is possible to reproduce the audio data for each user, according to a suitable quality which is set by each user.

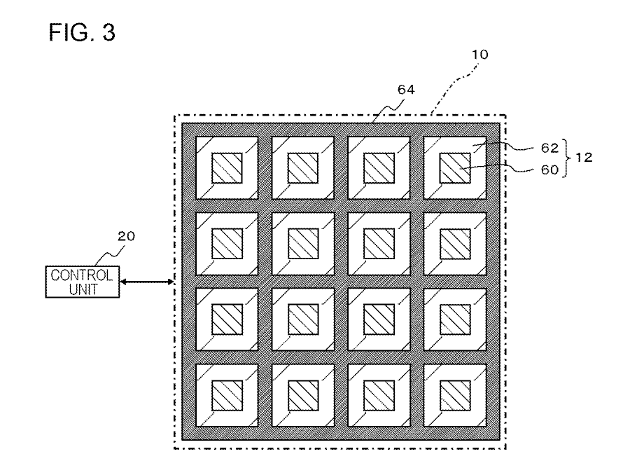

FIG. 3 is a plan view showing a parametric speaker 10 shown in FIG. 2. As shown in FIG. 3, the parametric speaker 10 is configured by, for example, arranging a plurality of oscillators 12 in an array shape.

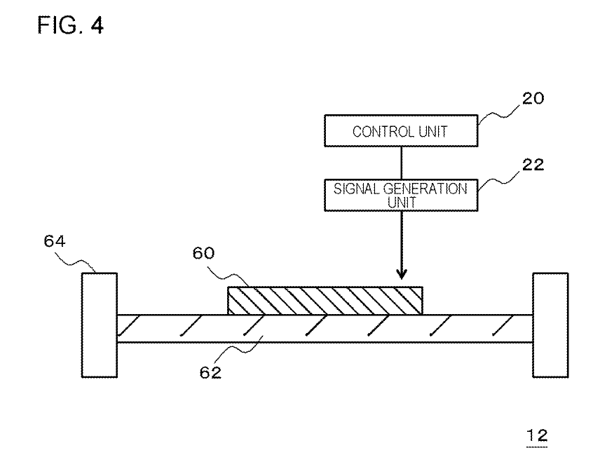

FIG. 4 is a cross-sectional view showing an oscillator 12 shown in FIG. 2. The oscillator 12 includes a piezoelectric vibrator 60, a vibrating member 62, and a supporting member 64. The piezoelectric vibrator 60 is provided in one side of the vibrating member 62. The supporting member 64 supports the circumference of the vibrating member 62.

The control unit 20 is connected to the piezoelectric vibrator 60 through the signal generation unit 22. The signal generation unit 22 generates an electric signal to be input to the piezoelectric vibrator 60. The control unit 20 controls the signal generation unit 22, based on information which is input from outside, thereby controlling the oscillation of the oscillator 12. The control unit 20 inputs a modulation signal of a parametric speaker through the signal generation unit 22 to the oscillator 12. At this time, the piezoelectric vibrator 60 uses a sound wave of 20 kHz or more, for example, 100 kHz, as a carrier wave of a signal.

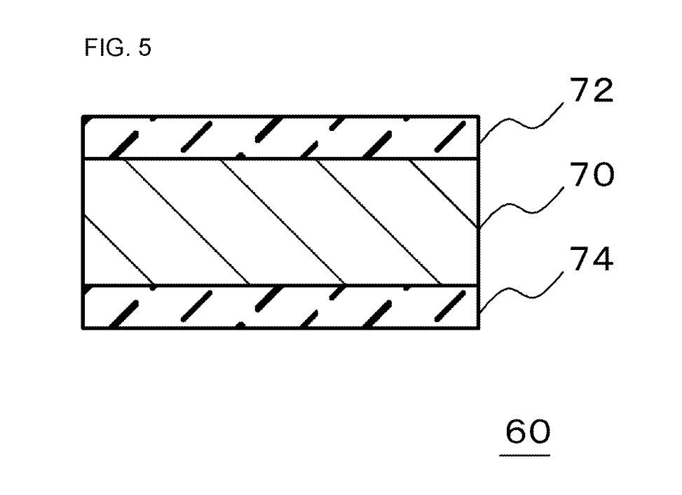

FIG. 5 is a cross-sectional view of a piezoelectric vibrator 60 shown in FIG. 4. As shown in FIG. 5, the piezoelectric vibrator 60 includes a piezoelectric body 70, an upper electrode 72 and a lower electrode 74. In addition, the piezoelectric vibrator 60 is, for example, circular or oval in a plan view. The piezoelectric body 70 is interposed between the upper electrode 72 and the lower electrode 74. In addition, the piezoelectric body 70 is polarized in the thickness direction. The piezoelectric body 70 is made from a material having a piezoelectric effect, for example, a zirconate titanate (PZT) or a barium titanate (BaTiO₃) which is a material having a high electro-mechanical conversion efficiency. In addition, it is preferable that the thickness of the piezoelectric body 70 be 10 μm or more and 1 mm or less. The piezoelectric body 70 is made from a brittle material. Therefore, when the thickness is less than 10 μm, damage in handling is likely to occur. On the other hand, when the thickness is over 1 mm, the electric field strength of the piezoelectric body 70 is reduced. Therefore, this causes the energy conversion efficiency to be reduced.

The upper electrode 72 and the lower electrode 74 are made from an electrically conductive material, for example, a silver, or a silver/palladium alloy, or the like. The silver is a general-purpose material with a low resistance, and is advantageous from the point of view of a manufacturing cost and a manufacturing process. In addition, the silver/palladium alloy is a low-resistance material with an excellent oxidation resistance, and is excellent in reliability. It is preferable that the thickness of the upper electrode 72 and the lower electrode 74 be 1 μm or more and 50 μm or less. When the thickness is less than 1 μm, it is difficult to have a uniform shape. In contrast, when the thickness is over 50 μm, the upper electrode 72 or the lower electrode 74 is a restraint surface for the piezoelectric body 70, and this leads to a decrease of the energy conversion efficiency.

The vibrating member 62 is made from a material having a high elastic modulus with respect to a ceramic which is a brittle material, such as a metal or a resin. The material of the vibrating member 62 includes, for example, a general-purpose material such as a phosphor bronze or a stainless steel. It is preferable that the thickness of the vibrating member 62 be 5 μm or more and 500 μm or less. In addition, it is preferable that the longitudinal elastic modulus of the vibrating member 62 be 1 GPa to 500 GPa. When the longitudinal elastic modulus of the vibrating member 62 is excessively low or high, there is a concern that the characteristics or reliability as a mechanical oscillator is impaired.

In the present embodiment, sound reproduction is performed using the operation principle of a parametric speaker. The operation principle of the parametric speaker is as follows. The operation principle of the parametric speaker is such that sound reproduction is performed under the principle that an ultrasonic wave which is subjected to an AM modulation, a DSB modulation, a SSB modulation, and an FM modulation is radiated into the air, and an audible sound is generated due to non-linear characteristics when the ultrasonic wave is propagated in the air. The “non-linear” referred to herein means a transition from a laminar flow to a turbulent flow, if the Reynolds number represented by the ratio between the inertia effect of a flow and the viscous effect is increased. In other words, since the sound wave is disturbed minutely within the fluid, the sound wave is propagated non-linearly. Particularly, when the ultrasonic wave is radiated into the air, harmonic waves due to the non-linear characteristics occur significantly. In addition, the sound wave is in a compressional state in which molecular groups in the air are dense or sparse. When it takes time for air molecule to be restored rather than compressed, the air which is not able to be restored after compression collides with continuously propagated air molecules to generate shock waves, and thus an audible sound is generated. The parametric speaker is able to form a sound field only around the user, and is excellent from the point of view of privacy protection.

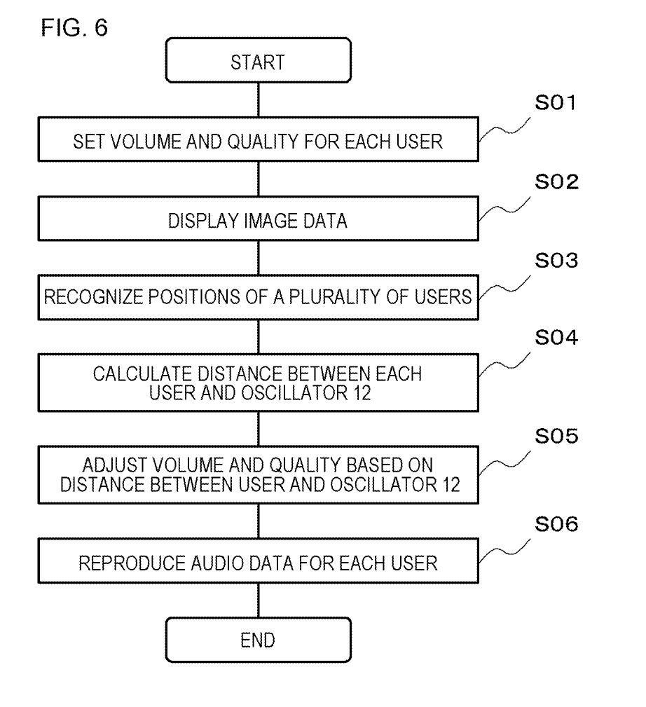

Subsequently, the operation of an electronic device 100 according to the present embodiment will be described. FIG. 6 is a flowchart of an operation method of the electronic device 100 shown in FIG. 1.

First, the volume and the quality of audio data associated with the image data which is displayed on the display 40 are set for each user (S01). Subsequently, the display 40 displays the image data (S02).

Subsequently, the recognition unit 30 recognizes the positions of a plurality of users (S03). Subsequently, the distance calculation unit 50 calculates a distance between each user and the oscillator 12 (S04). Subsequently, the volume and the quality of the audio data to be reproduced for each user is adjusted based on the distance between each user and the oscillator 12 (S05).

Subsequently, the audio data associated with the image data displayed on the display 40 is reproduced, according to the volume or the quality which is set for each user, toward the position of each user (S06). In addition, when the recognition unit 30 follows and recognizes the position of the user, the control unit 20 may constantly control the oscillator 12 to control the direction in which the audio data is reproduced, based on the position of the user recognized by the recognition unit 30.

Subsequently, the effect of the present embodiment will be described. According to the present invention, the oscillator outputs a modulated wave of a parametric speaker. In addition, the control unit controls the oscillator to reproduce the audio data associated with the image data displayed on the display, according to the volume or the quality which is set for each user, toward the position of each user. According to the configuration, the parametric speaker having a high directivity reproduces the audio data toward each user according to the volume or the quality which is set for each user. Accordingly, when a plurality of users simultaneously view the same content, it is possible to reproduce the audio of the different volume or quality for each user.

In this manner, according to the present embodiment, it is possible to reproduce an audio suitable for each user, when a plurality of users simultaneously view the same content.

### Second Embodiment

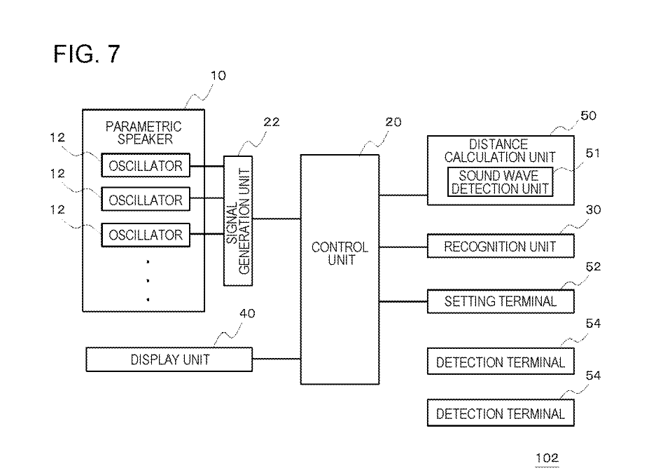

FIG. 7 is a block diagram showing an electronic device 102 according to a second embodiment, and corresponds to FIG. 2 according to the first embodiment. The electronic device 102 according to the present embodiment is the same as the electronic device 100 according to the first embodiment, except for including a plurality of detection terminals 54.

The plurality of detection terminals 54 are respectively held by a plurality of users. Then, the recognition unit 30 recognizes the position of the user by recognizing the position of the detection terminal 54. The recognition of the position of the detection terminal 54 by the recognition unit 30 is performed by, for example, the recognition unit 30 receiving a radio wave emitted from the detection terminal 54. In addition, when the user holding the detection terminal 54 moves, the recognition unit 30 may have a function of automatically following the user to determine the position of the user. When a plurality of setting terminals 52 are provided such that each user has each setting terminal 52, the detection terminal 54 may be integrally formed with the setting terminal 52, and include a function capable of selecting the volume or the quality of the audio data to be reproduced for each user.

In addition, the recognition unit 30 may include the imaging unit 32 and the determination unit 34. The imaging unit 32 generates image data obtained by capturing an area including the user, the determination unit 34 processes the image data, and thus it is possible to specify a specific position of the ear of the user, or the like. Accordingly, it is possible to recognize the position of the user more accurately by also performing the position detection using the detection terminal 54.

In the present embodiment, the control of the oscillator 12 by the control unit 20 is performed as follows.

First, an ID of each detection terminal 54 is registered in advance. Subsequently, the volume and the quality which are set for each user are associated with the ID of the detection terminal 54 held by each user. Subsequently, the ID indicating each detection terminal 54 is transmitted from each detection terminal 54. The recognition unit 30 recognizes the position of the detection terminal 54 based on the direction from which the ID has been transmitted. Then, the audio data corresponding to the setting is reproduced to the user holding the detection terminal 54 having the ID corresponding to the setting of the specific volume and quality.

Even in the present embodiment, the same effect as that of the first embodiment can be achieved.

### Third Embodiment

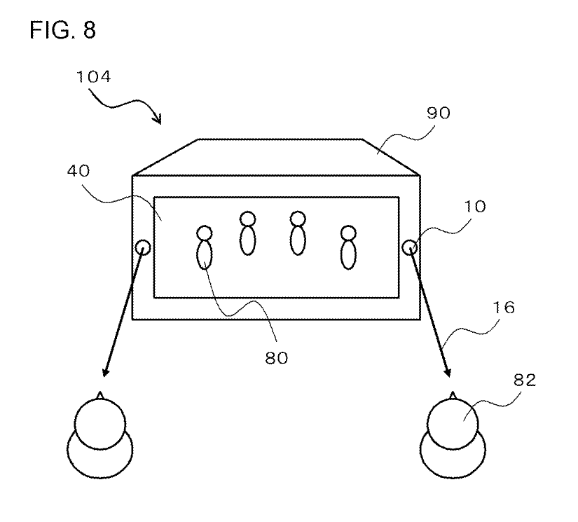

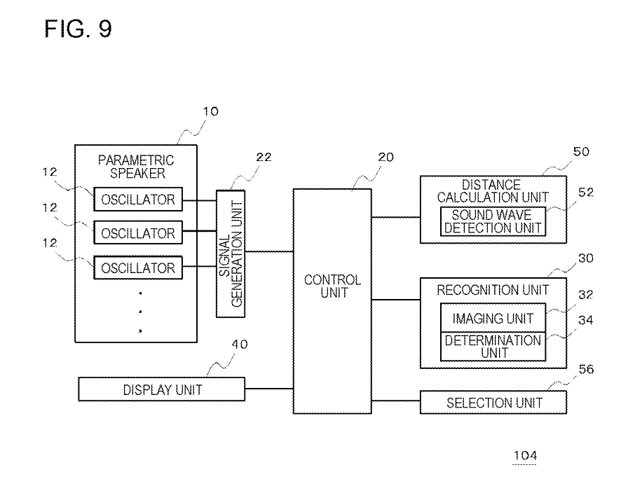

FIG. 8 is a schematic diagram showing an operation method of an electronic device 104 according to a third embodiment. In addition, FIG. 9 is a block diagram showing the electronic device 104 shown in FIG. 8. The electronic device 104 according to the present embodiment includes a parametric speaker 10 having a plurality of oscillators 12, a display 40, a recognition unit 30, and a control unit 20. The electronic device 104 is, for example, a television, a display for a digital signage, a portable terminal device, or the like. The portable terminal device is, for example, a mobile phone or the like.

The oscillator 12 outputs an ultrasonic wave 16. The ultrasonic wave 16 is a modulated wave of a parametric speaker. The display 40 displays image data including a plurality of display objects 80. The recognition unit 30 recognizes the positions of a plurality of users 82. The control unit 20 controls the oscillator 12 to reproduce a plurality of pieces of audio data respectively associated with the plurality of display objects 80 displayed on the display 40.

The control unit 20 controls the oscillator 12 to reproduce the audio data associated with the display object 80 selected by each user 82, toward the position of each user 82 which is recognized by the recognition unit 30. Hereinafter, the configuration of the electronic device 104 will be described in detail.

As shown in FIG. 8, the electronic device 104 includes a housing 90. The parametric speaker 10, the display 40, the recognition unit 30, and the control unit 20 are disposed, for example, inside the housing 90 (not shown).

The electronic device 104 receives or stores content data. The content data includes audio data and image data. The image data out of the content data is displayed on the display 40. In addition, the audio data out of the content data is output by the plurality of oscillators 12.

The image data out of the content data includes a plurality of display objects 80. The plurality of display objects 80 are respectively associated with separate audio data. When the content data is a concert, the plurality of display objects 80 are, for example, respective players. In this case, the plurality of display objects 80, for example, is respectively associated with the audio data which reproduces the tone of the musical instrument played by each player.

As shown in FIG. 9, the recognition unit 30 includes an imaging unit 32 and a determination unit 34. The imaging unit 32 captures an area including a plurality of users 82 to generate image data. The determination unit 34 processes the image data captured by the imaging unit 32 and determines the position of each user 82. For example, a characteristic value for identifying each user 82 is stored and preserved individually in advance, and the characteristic value is compared with the image data so as to perform the determination of the position of each user 82. The characteristic value is, for example, a size of an interval of both eyes, a size or a shape of a triangle formed by connecting both eyes and the nose, or the like.

The recognition unit 30 can specify, for example, the position of the ear of the user 82, or the like. In addition, when the user 82 moves within the area in which the imaging unit 32 captures an image, the recognition unit 30 may have a function of automatically following the user 82 and determining the position of the user 82.

As shown in FIG. 9, the electronic device 104 includes a distance calculation unit 50. The distance calculation unit 50 calculates distance between each user 82 and the oscillator 12.

As shown in FIG. 9, the distance calculation unit 50 includes, for example, a sound wave detection unit 52. In this case, the distance calculation unit 50 calculates the distance between each user 82 and the oscillator 12 in the following manner. First, an ultrasonic wave for a sensor is output from the oscillator 12. Subsequently, the distance calculation unit 50 detects an ultrasonic wave for a sensor which is reflected from each user 82. Then, based on time from when the ultrasonic wave for a sensor is output by the oscillator 12 until it is detected by the sound wave detection unit 52, the distance between each user 82 and the oscillator 12 is calculated. In addition, when the electronic device 104 is a mobile phone, the sound wave detection unit 52 may be configured with, for example, a microphone.

As shown in FIG. 9, the electronic device 104 includes a selection unit 56. Each user 82 selects any one out of a plurality of display objects 80 included in the image data displayed on the display 40, using the selection unit 56.

The selection unit 56 is incorporated, for example, inside the housing 90. In addition, the selection unit 56 may not be incorporated inside the housing 90. In this case, a plurality of the selection units 56 may be provided in order for each of the plurality of users 82 to hold each one of the selection unit 56.

As shown in FIG. 9, the control unit 20 is connected to the plurality of oscillators 12, the recognition unit 30, the display 40, the distance calculation unit 50, and the selection unit 56. In the present embodiment, the control unit 20 controls the plurality of oscillators 12 to reproduce the audio data associated with the display objects 80 selected by each user 82 toward the position of each user 82. This is performed, for example, in the following manner.

First, the characteristic value of each user 82 is registered in association with ID, for each user 82. Subsequently, the display object 80 selected by each user 82 is stored in association with an ID of each user 82. Subsequently, the ID associated with the specific display object 80 is selected, and the characteristic value associated with the selected ID is read. Subsequently, the user 82 having the characteristic value which is read is selected by an image process. Then, the audio data associated with the display object 80 is reproduced for the user 82.

In addition, the control unit 20 adjusts the volume and the quality of the audio data reproduced for each user 82, based on the distance between each user 82 and the oscillator 12, which is calculated by the distance calculation unit 50.

The parametric speaker 10 in the present embodiment has the same configuration as, for example, the parametric speaker 10 according to the first embodiment shown in FIG. 3.

The oscillator 12 in the present embodiment has the same configuration as, for example, the oscillator 12 according to the first embodiment shown in FIG. 4.

The piezoelectric vibrator 60 in the present embodiment has the same configuration as, for example, the piezoelectric vibrator 60 according to the first embodiment shown in FIG. 5.

In the present embodiment, sound reproduction is performed, for example, using an operation principle of the parametric speaker, the same as the first embodiment.

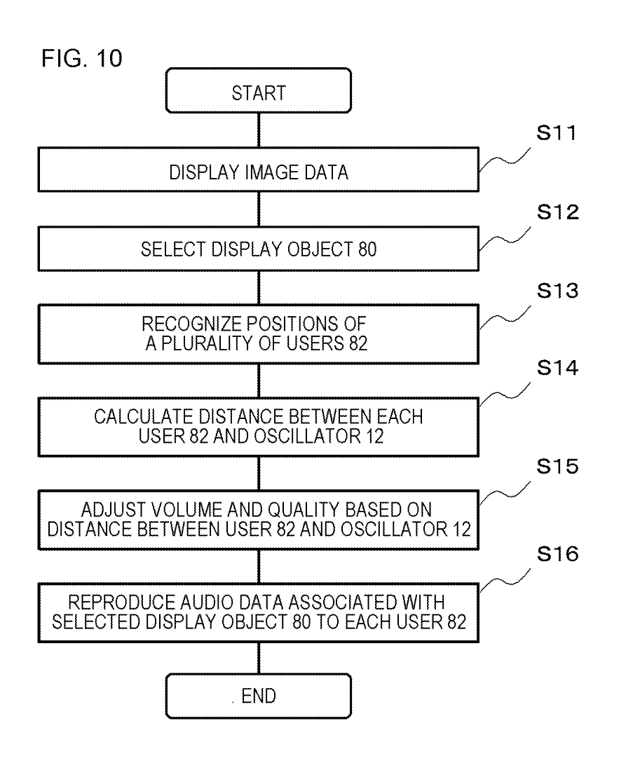

Subsequently, the operation of the electronic device 104 according to the present embodiment will be described. FIG. 10 is a flowchart of an operation method of the electronic device 104 shown in FIG. 8.

First, the display 40 displays image data (S11). Subsequently, the user 82 selects anyone out of the plurality of display objects 80 included in the imaged data displayed on the display 40 (S12).

Subsequently, the recognition unit 30 recognizes the positions of a plurality of users 82 (S13). Subsequently, the distance calculation unit 50 calculates a distance between each user 82 and the oscillator 12 (S14). Subsequently, the volume and the quality of the audio data to be reproduced for each user 82 is adjusted based on the distance between each user 82 and the oscillator 12 (S15).

Subsequently, the audio data associated with the display object 80 selected by each user 82 is reproduced toward the position of each user 82 (S16). In addition, when the recognition unit 30 follows and recognizes the position of the user 82, the control unit 20 may constantly control the oscillator 12 to control the direction in which the audio data is reproduced, based on the position of the user 82 recognized by the recognition unit 30.

Subsequently, the effect of the present embodiment will be described. According to the present embodiment, the oscillator 12 outputs the modulated wave of the parametric speaker. In addition, control unit 20 controls the oscillator 12 to reproduce the audio data associated with the display object 80 selected by each user 82 toward the position of each user 82.

According to the configuration, since the parametric speaker having high directivity is used, the audio data reproduced for each user does not interfere with each other. Then, using such a parametric speaker, the audio data associated with the display object 80 selected by each user 82 is reproduced to each user 82. Accordingly, when a plurality of users simultaneously view the same content, it is possible to reproduce separate audio data associated with the separate display object which is displayed in the content, for each user.

In this manner, according to the present embodiment, when a plurality of users simultaneously view the same content, it is possible to reproduce a proper audio for each user.

### Fourth Embodiment

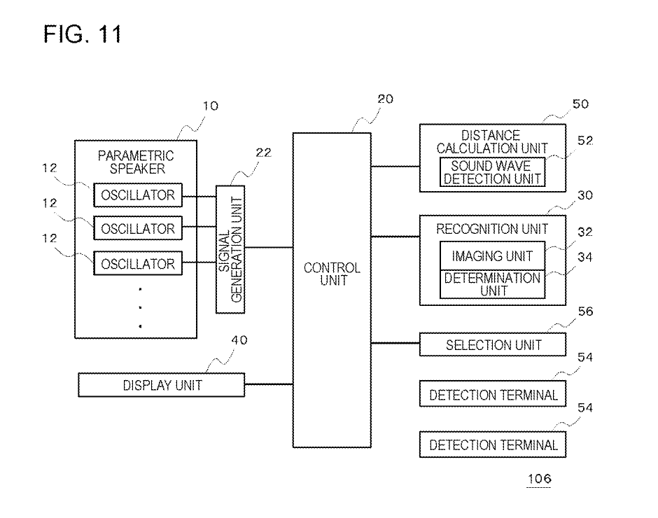

FIG. 11 is a block diagram showing an electronic device 106 according to a fourth embodiment, and corresponds to FIG. 9 according to the third embodiment. The electronic device 106 according to the present embodiment is the same as the electronic device 104 according to the third embodiment, except for including a plurality of detection terminals 54.

The plurality of detection terminals 54 are respectively held by a plurality of users 82. Then, the recognition unit 30 recognizes the position of the user 82 by recognizing the position of the detection terminal 54. The recognition of the position of the detection terminal 54 by the recognition unit 30 is performed by, for example, the recognition unit 30 receiving a radio wave emitted from the detection terminal 54.

In addition, when the user 82 holding the detection terminal 54 moves, the recognition unit 30 may have a function of automatically following the user 82 to determine the position of the user 82. When a plurality of selection units 56 are provided such that each user 82 holds each selection unit 56, the detection terminal 54 may be integrally formed with the selection unit 56.

Further, the recognition unit 30 may include the imaging unit 32 and the determination unit 34. The imaging unit 32 generates image data by capturing an area, where the user 82 is located, which is recognized by recognizing the position of the detection terminal 54. The determination unit 34 processes the image data generated by the imaging unit 32 to determine the position of the ear of each user 82. Thus, it is possible to recognize more accurate position of the user 82, by also performing the position detection using the detection terminal 54.

In the present embodiment, the control of the oscillator 12 by the control unit 20 will be performed in the following manner.

First, an ID of each detection terminal 54 is registered in advance. Subsequently, the volume and the quality which are set for each user 82 are associated with the ID of the detection terminal 54 held by each user 82. Subsequently, the ID indicating each detection terminal 54 is transmitted from each detection terminal 54. The recognition unit 30 recognizes the position of the detection terminal 54, based on the direction from which the ID has been transmitted. Then, the audio data according to the setting is reproduced to the user 82 holding the detection terminal 54 having the ID associated with the setting of the specific volume and quality.

Even in the present embodiment, the same effect as that of the third embodiment can be achieved.

Hitherto, although embodiments of the present invention have been described with reference to drawings, they are only examples of the present invention, but other various configurations can be adopted.

This application claims priority based on Japanese Patent Application No. 2011-195759 filed on Sep. 8, 2011 and Japanese Patent Application No. 2011-195760 filed on Sep. 8, 2011, incorporated herein in its entirety by disclosure.

1. An electronic device comprising:
a plurality of oscillators each of which outputs a modulated wave of a parametric speaker;
a display that displays a first image data;
a recognition unit that recognizes positions of a plurality of users; and
a control unit that controls the oscillator to reproduce audio data associated with the first image data,
wherein the control unit controls the oscillator to reproduce the audio data, according to a volume and a quality which are set for each user, toward the position of each user which is recognized by the recognition unit.

2. The electronic device according to claim 1, further comprising:
a distance calculation unit that calculates a distance between each user and the oscillator,
wherein the control unit adjusts the volume and the quality of the audio data to be reproduced for each user, based on the distance between each user and the oscillator, which is calculated by the distance calculation unit.

3. The electronic device according to claim 1,
wherein the recognition unit includes:
an imaging unit that captures an area including the plurality of users to generate a second image data; and
a determination unit that determines the positions of the plurality of users by processing the second image data.

4. The electronic device according to claim 1, further comprising:
a plurality of detection terminals that are respectively held by the plurality of users,
wherein the recognition unit recognizes the position of the user by recognizing the position of the detection terminal.

5. The electronic device according to claim 1,
wherein the recognition unit follows and recognizes the position of the user, and
wherein the control unit constantly controls a direction in which the oscillator outputs audio, based on the position of the user recognized by the recognition unit.

6. The electronic device according to claim 1, further comprising:
a setting terminal that sets the volume or the quality of the audio data associated with the first image data for each user.

7. The electronic device according to claim 1,
wherein the electronic device is a portable terminal device.

8. An electronic device comprising:
a plurality of oscillators each of which outputs a modulated wave of a parametric speaker;
a display that displays a first image data including a plurality of display objects;
a recognition unit that recognizes positions of a plurality of users; and
a control unit that controls the oscillator to reproduce a plurality of pieces of audio data respectively associated with the plurality of display objects,
wherein the control unit controls the oscillator to reproduce the audio data associated with the display object selected by each user, toward the position of each user which is recognized by the recognition unit.

9. The electronic device according to claim 8,
wherein the recognition unit includes:
an imaging unit that captures an area including the plurality of users to generate a second image data; and
a determination unit that determines the positions of the plurality of users by processing the second image data.

10. The electronic device according to claim 8, further comprising:
a plurality of detection terminals that are respectively held by the plurality of users,
wherein the recognition unit recognizes the position of the user by recognizing the position of the detection terminal.

11. The electronic device according to claim 10, wherein the recognition unit includes:
an imaging unit that captures an area, where the user is located, which is recognized by recognizing the position of the detection terminal to generate a second image data; and
a determination unit that determines the position of the ear of the user by processing the second image data.

12. The electronic device according to claim 8,
wherein the recognition unit follows and recognizes the position of the user, and
wherein the control unit constantly controls a direction in which the oscillator reproduces the audio data, based on the position of the user recognized by the recognition unit.

13. The electronic device according to claim 8, further comprising:
a distance calculation unit that calculates a distance between each user and the oscillator,
wherein the control unit adjusts the volume and the quality of the audio data to be reproduced for each user, based on the distance between each user and the oscillator, which is calculated by the distance calculation unit.

14. The electronic device according to claim 8,
wherein the electronic device is a portable terminal device.
